(19) United States
(12) Patent Application Publication
(10) Pub. No.: US 2014/0142910 A1
(43) Pub. Date: May 22, 2014

(54) HANDHELD DEVICE AND METHOD FOR SIMULATING FLIGHT PATH OF BOOMERANG

(71) Applicant: HON HAI PRECISION INDUSTRY CO., LTD., New Taipei (TW)

(72) Inventor: CHIH-YUAH TSAI, New Taipei (TW)

(73) Assignee: HON HAI PRECISION INDUSTRY CO., LTD., New Taipei (TW)

(21) Appl. No.: 14/077,226

(22) Filed: Nov. 12, 2013

(30) Foreign Application Priority Data
Nov. 22, 2012 (TW) 101143775

(51) Int. Cl. G06F 17/50

(52) U.S. Cl. CPC G06F 17/5009
USPC 703/2

(57) ABSTRACT

In a method for simulating a flight path of a boomerang on a display screen of a handheld device, the method obtains accelerations and rotation angles of the handheld device, determines a flight path of an image of the boomerang according to the accelerations, the rotation angles of the handheld device, and preset simulation equations, and displays the flight path of the image of the boomerang on the display screen of the handheld device.

### BACKGROUND

1. Technical Field

Embodiments of the present disclosure relate to simulation technology, and particularly to a handheld device and a method for simulating flight path of a boomerang on a display screen of a handheld device.

2. Description of Related Art

Acceleration sensors and electronic gyroscopes are usually embedded in handheld devices (e.g., cell phones, computer tablets) to detect movements of the handheld devices, so that many electronic games can be played on a display screen of the handheld device according to the movements of the handheld device. However, there is no electronic game of boomerang taking advantage of the acceleration sensor and electronic gyroscope of the handheld device. Therefore, a method for simulating flight path of boomerang on the display screen of the handheld device is desired.

### BRIEF DESCRIPTION OF THE DRAWINGS

FIG. 1 is a schematic diagram of one embodiment of a handheld device including a boomerang game simulating system.

FIG. 2 is a schematic diagram of function modules of the boomerang game simulating system included in the handheld device.

FIG. 3 is a flowchart of one embodiment of a method for simulating a flight path of boomerang on a display screen of the handheld device.

FIGS. 4-6 are schematic diagrams of the flight principle of the boomerang.

FIG. 7 is a schematic diagram of obtaining a throwing angle of the boomerang.

FIG. 8 is a schematic diagram of an X-Y-Z axes coordinate system of the handheld device.

FIG. 9 is a schematic diagram of a flight path of an image of the boomerang on a display screen of the handheld device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

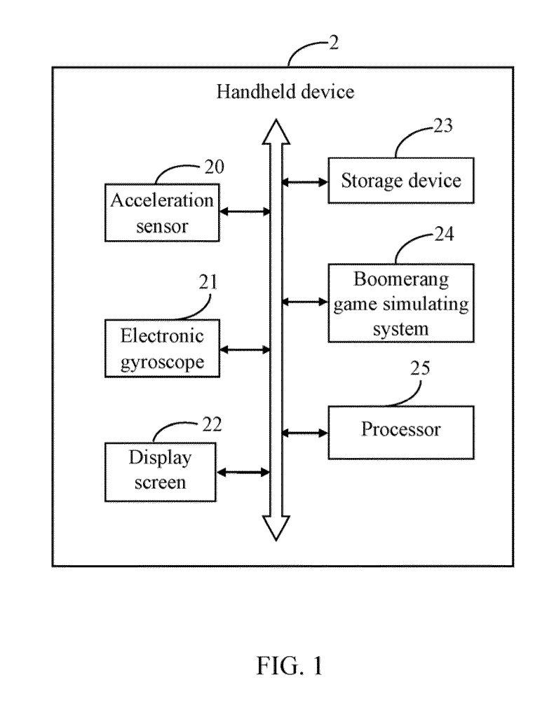

FIG. 1 is a block diagram of one embodiment of a handheld device 2 including a boomerang game simulating system 24. The handheld device 2 further includes an acceleration sensor (e.g., an accelerometer) 20, an electronic gyroscope 21, a display screen 22, a storage device 23, and at least one processor 25. It should be understood that FIG. 1 illustrates only one example of the handheld device 2 that may include more or fewer components than illustrated, or a different configuration of the various components in other embodiments. In one embodiment, the handheld device 2 may be a smart phone.

In one embodiment, the acceleration sensor 20 is used to detect an acceleration of the handheld device 2 at each preset time interval (e.g., one second). The electronic gyroscope 21 is used to detect a rotation angle of the handheld device 2 at each preset time interval. For example, the acceleration sensor 20 may be a two-axis accelerator, a three-axis accelerator, the electronic gyroscope 21 may be a two-axis gyro or a three-axis gyro.

The boomerang game simulating system 24 is used to detect movement parameters (e.g., the accelerations and the rotation angles) of the handheld device 2 using the acceleration sensor 20 and the electronic gyroscope 21, and display a simulated flight path of an image of the boomerang on the display screen 22 according to the detected movement parameters of the handheld device 2. In one embodiment, the boomerang game simulating system 24 may include computerized instructions in the form of one or more programs that are executed by the processor 25 and stored in the storage device 23 (or memory). A detailed description of the boomerang game simulating system 24 will be given in the following paragraphs.

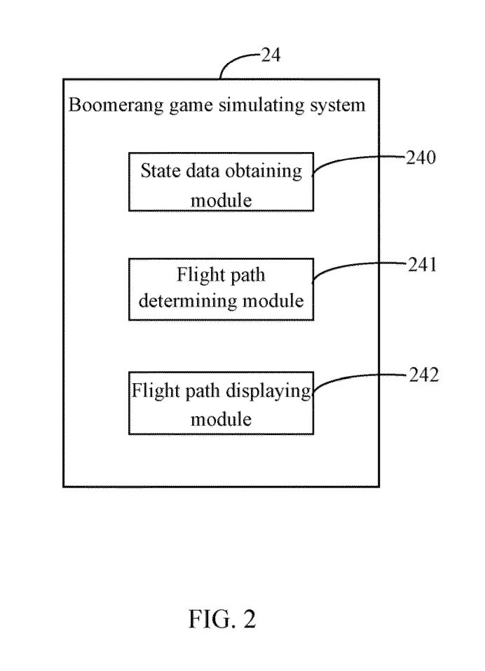

FIG. 2 is a block diagram of function modules of the boomerang game simulating system 24 included in the handheld device 2. In one embodiment, the boomerang game simulating system 24 may include one or more modules, for example, a state data obtaining module 240, a flight path determining module 241, and a flight path displaying module 242. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

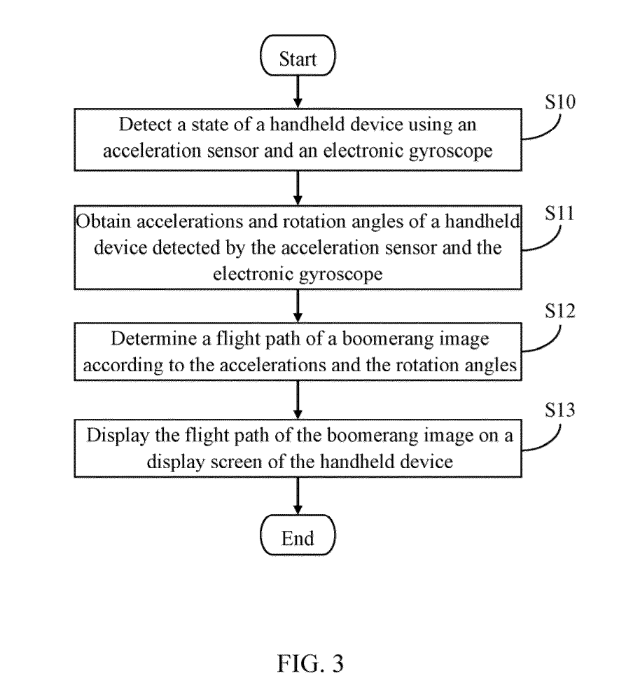

FIG. 3 is a flowchart of one embodiment of a method for simulating a flight path of the boomerang on the display screen 22 of the handheld device 2. Depending on the embodiment, additional steps may be added, others removed, and the ordering of the steps may be changed.

Before introducing the method shown in FIG. 3, the flight principle of the boomerang is described at first.

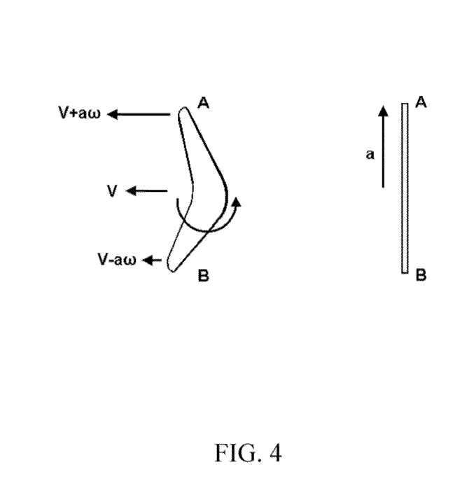

FIG. 4 shows that the forces acting on a boomerang of radius “a”. A centre of the boomerang moves at a linear velocity (also can be called as “forward velocity”) V and the boomerang spins with an angular velocity ω as shown in FIG. 4. The top end “A” moves faster than V with speed V+aω and the bottom end “B” moves slower with speed V−aω.

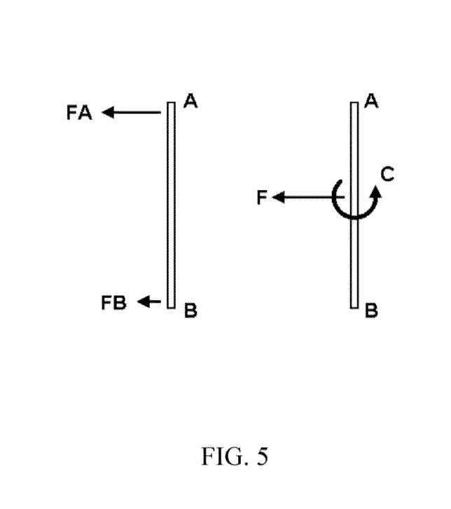

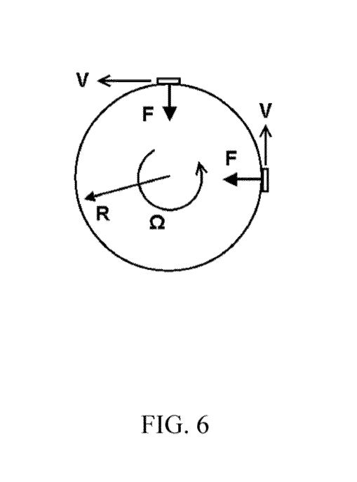

According to the Bernoulli's principle, a wing generates more lift force when it is moving faster so point A generates more lift force than point B. “FA” in FIG. 5 represents the lift force acting on the point A, “FB” in FIG. 5 represents the lift force acting on the point B. The two lift forces FA and FB may be represented by a centripetal force F and a torque C using the following two equations.

F=mV²/R (1)

C=JωΩ (2)

In the two equations, “m” represents a mass of the boomerang, “R” represents a radius of a flight path of the boomerang, “J” represents an angular momentum of the boomerang, and “Ω” represents a rate of precession in radians/sec. The flight path of the boomerang may be determined using the two equations. An throwing angle “θ” of the boomerang is determined according to movement data of the handheld device 2, and an optimized throwing angle is between ten degrees and thirty degrees.

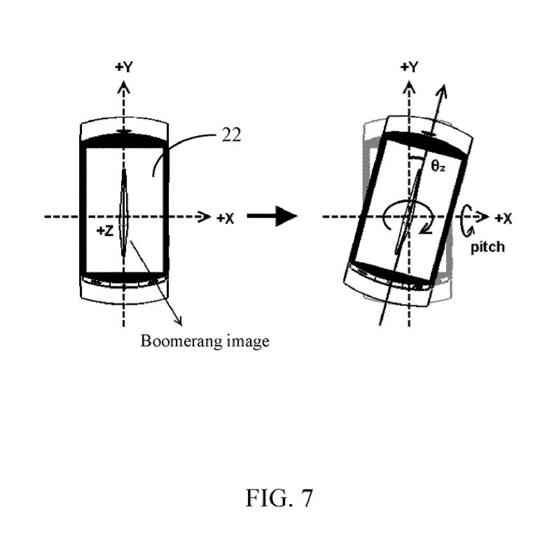

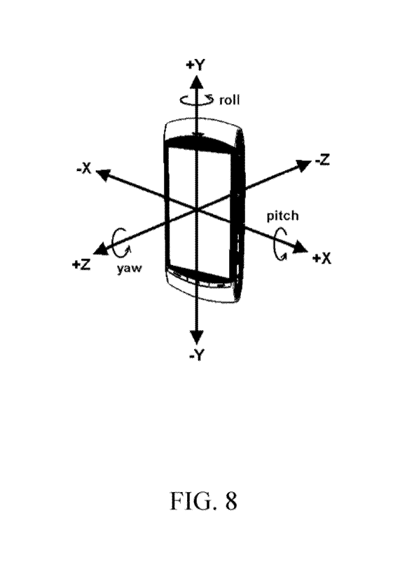

In step S10, the state data obtaining module 240 detects a state of the handheld device 2 using the acceleration sensor 20 and the electronic gyroscope 21 when the user starts a boomerang simulation game in the handheld device 2. When the boomerang simulation game is played, the user may rotate the handheld device 2 around an X-axis, a Y-axis, and an Z-axis of a coordinate system constructed based on the handheld device 2. Then, the electronic gyroscope 21 detects a rotation angle “θₓ” around the X-axis of the handheld device 2 (hereinafter referred to as “X-axis rotation angle”), a rotation angle “θ_{y}” around the Y-axis of the handheld device 2 (hereinafter referred to as “Y-axis rotation angle”), and a rotation angle “θ_{Z}” around the Z-axis of the handheld device 2 (hereinafter referred to as “Z-axis rotation angle”). In one embodiment, the Z-axis rotation angle “θ_{Z}” is equal to the throwing angle “θ” of an image of the boomerang on the display screen 22 (as shown in FIG. 7). As shown in FIG. 8, the coordinate system is constructed based on the display screen 22 of the handheld device 2, for example, the X-axis is a width of the display screen 22, the Y-axis is a height of the display screen 22, and the Z-axis is perpendicular to the plane of the display screen 22.

In step S11, the state data obtaining module 240 obtains accelerations and rotation angles of the handheld device 2, which are detected by the acceleration sensor 20 and the electronic gyroscope 21 at each preset time interval (e.g., one second). In one embodiment, the accelerations of the handheld device 2 may include an acceleration of the handheld device 2 towards an X-axis direction (hereinafter referred to as “X-axis acceleration”), an acceleration of the handheld device 2 towards a Y-axis direction (hereinafter referred to as “Y-axis acceleration”), and an acceleration of the handheld device 2 towards an Z-axis direction (hereinafter referred to as “Z-axis acceleration”). The rotation angles of the handheld device 2 may include an X-axis rotation angle “θₓ” of the handheld device, a Y-axis rotation angle “θ_{y}” of the handheld device, and an Z-axis rotation angle “θ_{z}” of the handheld device.

In step S12, the flight path determining module 241 determines a flight path of the image of the boomerang (hereinafter referred to as “boomerang image”) according to the accelerations and the rotation angles of the handheld device 2. In one embodiment, the flight path of the boomerang image is simulated using the above-mentioned equations (1) and (2). When the boomerang simulation game is played, the user rotates the handheld device 2. The acceleration sensor 20 and the electronic gyroscope 21 detects the accelerations and the rotation angles of the handheld device 2 to determine the flight path of the boomerang image on the display screen 22.

In one embodiment, the flight path determining module 241 determines a direction of the linear velocity V of the boomerang image on an X-Y plane of the display screen 22 according to the X-axis rotation angle “θₓ” and the Y-axis rotation angle “θ_{y}” of the handheld device 2, and determines a value of the linear velocity V of the boomerang image according to the Z-axis acceleration of the handheld device 2. For example, the value of the linear velocity V of the boomerang image is equal to the Z-axis acceleration of the handheld device 2. The angular velocity ω of the boomerang image is determined according to the X-axis rotation angle “θₓ” of the handheld device 2. For example, the angular velocity ω of the boomerang image is equal to the X-axis rotation angle “θₓ” of the handheld device 2 per in second.

After determining the direction and the value of linear velocity V of the boomerang image, the angular velocity ω of the boomerang image, and the throwing angle “θ” of the boomerang image, the flight path of the boomerang image on the display screen 22 are determined according to the simulation equations (1) and (2). In the simulation equations (1) and (2), the radius “R” of the flight path of the boomerang image and the rate of precession “Ω” may be predetermined values. For example, R=4 cm (centimeters), and Ω=1 radians/sec.

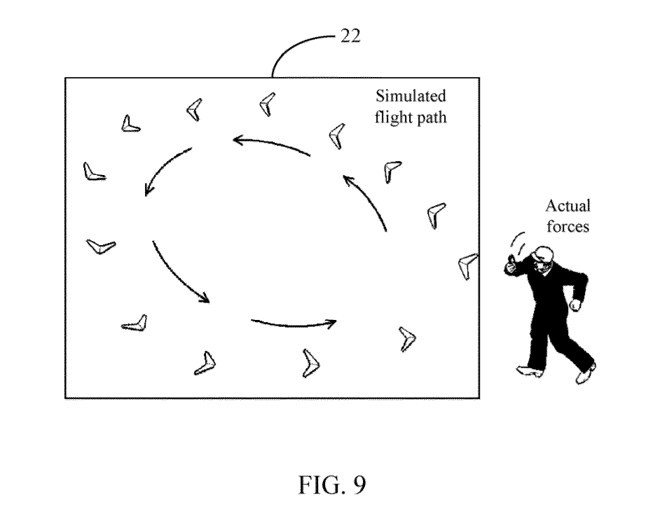

In step S13, the flight path displaying module 242 displays the flight path of the boomerang image on the display screen 22 of the handheld device 2, so that the boomerang simulation game is simulated on the display screen 22 of the handheld device 2 (as shown in FIG. 9).

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for simulating a flight path of a boomerang on a display screen of a handheld device, the method comprising:
obtaining accelerations of the handheld device detected by an acceleration sensor of the handheld device, and obtaining rotation angles of the handheld device detected by an electronic gyroscope of the handheld device;
determining a flight path of an image of the boomerang according to the accelerations and the rotation angles of the handheld device, and preset simulation equations; and
displaying the flight path of the image of the boomerang on the display screen of the handheld device.

2. The method according to claim 1, wherein the accelerations of the handheld device comprise an X-axis acceleration, a Y-axis acceleration, and an Z-axis acceleration of the handheld device, the rotation angles of the handheld device comprise an X-axis rotation angle, a Y-axis rotation angle, and an Z-axis rotation angle of the handheld device.

3. The method according to claim 2, wherein the preset simulation equations comprise an throwing angle of the image of the boomerang, a direction and a value of a linear velocity of the image of the boomerang, and an angular velocity of the image of the boomerang.

4. The method according to claim 3, wherein the throwing angle of the image of the boomerang is determined as the Z-axis rotation angle of the handheld device.

5. The method according to claim 3, wherein the direction of the linear velocity of the image of the boomerang is determined according to the X-axis rotation angle and the Y-axis rotation angle of the handheld device, and the value of the linear velocity of the image of the boomerang image is determined according to the Z-axis acceleration of the handheld device.

6. The method according to claim 3, wherein the angular velocity of the image of the boomerang is determined according to the X-axis rotation angle of the handheld device.

7. A handheld device, comprising:
a processor;
a storage device storing a plurality of instructions, which when executed by the processor, causes the processor to:
obtain accelerations of the handheld device detected by an acceleration sensor of the handheld device, and obtain rotation angles of the handheld device detected by an electronic gyroscope of the handheld device;
determine a flight path of an image of the boomerang according to the accelerations and the rotation angles of the handheld device, and preset simulation equations; and
display the flight path of the image of the boomerang on a display screen of the handheld device.

8. The handheld device according to claim 7, wherein the accelerations of the handheld device comprise an X-axis acceleration, a Y-axis acceleration, and an Z-axis acceleration of the handheld device, the rotation angles of the handheld device comprise an X-axis rotation angle, a Y-axis rotation angle, and an Z-axis rotation angle of the handheld device.

9. The handheld device according to claim 8, wherein the preset simulation equations comprise an throwing angle of the image of the boomerang, a direction and a value of a linear velocity of the image of the boomerang, and an angular velocity of the image of the boomerang.

10. The handheld device according to claim 9, wherein the throwing angle of the image of the boomerang is determined as the Z-axis rotation angle of the handheld device.

11. The handheld device according to claim 9, wherein the direction of the linear velocity of the image of the boomerang is determined according to the X-axis rotation angle and the Y-axis rotation angle of the handheld device, and the value of the linear velocity of the image of the boomerang image is determined according to the Z-axis acceleration of the handheld device.

12. The handheld device according to claim 9, wherein the angular velocity of the image of the boomerang is determined according to the X-axis rotation angle of the handheld device.

13. A non-transitory storage medium having stored thereon instructions that, when executed by a processor of a handheld device, causes the electronic device to perform a method for simulating a flight path of a boomerang on a display screen of the handheld device, the method comprising:
obtaining accelerations of the handheld device detected by an acceleration sensor of the handheld device, and obtain rotation angles of the handheld device detected by an electronic gyroscope of the handheld device;
determining a flight path of an image of the boomerang according to the accelerations and the rotation angles of the handheld device, and preset simulation equations; and
displaying the flight path of the image of the boomerang on the display screen of the handheld device.

14. The non-transitory storage medium according to claim 13, wherein the accelerations of the handheld device comprise an X-axis acceleration, a Y-axis acceleration, and an Z-axis acceleration of the handheld device, the rotation angles of the handheld device comprise an X-axis rotation angle, a Y-axis rotation angle, and an Z-axis rotation angle of the handheld device.

15. The non-transitory storage medium according to claim 14, wherein the preset simulation equations comprise an throwing angle of the image of the boomerang, a direction and a value of a linear velocity of the image of the boomerang, and an angular velocity of the image of the boomerang.

16. The non-transitory storage medium according to claim 15, wherein the throwing angle of the image of the boomerang is determined as the Z-axis rotation angle of the handheld device.

17. The non-transitory storage medium according to claim 15, wherein the direction of the linear velocity of the image of the boomerang is determined according to the X-axis rotation angle and the Y-axis rotation angle of the handheld device, and the value of the linear velocity of the image of the boomerang image is determined according to the Z-axis acceleration of the handheld device.

18. The non-transitory storage medium according to claim 15, wherein the angular velocity of the image of the boomerang is determined according to the X-axis rotation angle of the handheld device.
